(19) United States
(12) Patent Application Publication
(10) Pub. No.: US 2006/0284770 A1
(43) Pub. Date: Dec. 21, 2006

(54) Compact dual band antenna having common elements and common feed

(76) Inventors: Young-Min Jo, Viera, FL (US); Frank M. Caimi, Vero Beach, FL (US); Dong-Gu Lee, Seoul (KR)

Correspondence Address: BEUSSE WOLTER SANKS MORA & MAIRE, P. A., 390 NORTH ORANGE AVENUE, SUITE 2500, ORLANDO, FL, 32801, US

(21) Appl. No.: 11/153,891

(22) Filed: Jun. 15, 2005

(51) Int. Cl. H01Q 1/38

(52) U.S. Cl. 343/700 MS

(57) ABSTRACT

A dual band antenna comprising structurally different antenna elements and having common feed. The antenna includes a ground plane, a radiating element and an arm extending from the radiating element. In a first operating mode energy is radiated from the arm, the radiating element and the ground plane. In a second operating mode energy is radiated from the radiating element and the ground plane. Thus the antenna operates in two modes with two different resonant frequencies.

### FIELD OF THE INVENTION

The present invention relates generally to antennas and more specifically to a dual band antenna capable of operation in at least two frequency bands from a single ground and feed terminal.

### BACKGROUND OF THE INVENTION

It is generally known that antenna performance is dependent on the size, shape and material composition of the constituent antenna elements, as well as the relationship between certain antenna physical parameters (e.g., length for a linear antenna and diameter for a loop antenna) and the wavelength of the signal received or transmitted by the antenna. These relationships determine several antenna operational parameters, including input impedance, gain, directivity, signal polarization, operating frequency, bandwidth and radiation pattern. Generally for an operable antenna, the minimum physical antenna dimension (or the electrically effective minimum dimension) must be on the order of a half wavelength (or a multiple thereof) of the operating frequency, which thereby advantageously limits the energy dissipated in resistive losses and maximizes the transmitted energy. Alternatively, a quarter-wavelength antenna operating over a ground plane performs similarly to a half-wavelength antenna. Quarter-wavelength and half-wavelength antennas are the most commonly used.

The burgeoning growth of wireless communications devices and systems has created a substantial need for physically smaller, less obtrusive, and more efficient antennas that are capable of wide bandwidth or multiple frequency-band operation, and/or operation in multiple modes (e.g., selectable radiation patterns or selectable signal polarizations). Smaller packaging of state-of-the-art communications devices, such as cellular handsets and personal digital assistants, do not provide sufficient space for the conventional quarter and half wavelength antenna elements. Thus physically smaller antennas operating in the frequency bands of interest and providing the other desirable antenna operating properties (input impedance, radiation pattern, signal polarizations, etc.) are especially sought after.

As is known to those skilled in the art, there is a direct relationship between physical antenna size and antenna gain, at least with respect to a single-element antenna, according to the relationship: gain=(βR)ˆ2+2βR, where R is the radius of the sphere containing the antenna and β is the propagation factor. Increased gain thus requires a physically larger antenna, while communications equipment manufacturers and users continue to demand physically smaller antennas. As a further constraint, to simplify the system design and packaging, and strive for a minimum cost, equipment designers and system operators prefer to utilize antennas capable of efficient multi-band and/or wide bandwidth operation, allowing the communications device to access various wireless services operating within different frequency bands from a single antenna. Finally, gain is limited by the known relationship between the antenna frequency and the effective antenna length (expressed in wavelengths). That is, the antenna gain is constant for all quarter wavelength antennas of a specific geometry i.e., at that operating frequency where the effective antenna length is a quarter wavelength of the operating frequency.

The known Chu-Harrington relationship relates the size and bandwidth of an antenna. Generally, as the size decreases the antenna bandwidth also decreases. But to the contrary, as the capabilities of handset communications devices expand to provide for higher data rates and the reception of bandwidth intensive information (e.g., streaming video), the antenna bandwidth must be increased.

One basic antenna commonly used in many applications today is the half-wavelength dipole antenna. The radiation pattern is the familiar omnidirectional donut shape with most of the energy radiated uniformly in the azimuth direction and little radiation in the elevation direction. Frequency bands of interest for certain communications devices are 1710 to 1990 MHz and 2110 to 2200 MHz. A half-wavelength dipole antenna is approximately 3.11 inches long at 1900 MHz, 3.45 inches long at 1710 MHz, and 2.68 inches long at 2200 MHz. The typical antenna gain is about 2.15 dBi. Clearly, such antennas are not acceptable for handheld communications devices.

The quarter-wavelength monopole antenna placed above a ground plane is derived from a half-wavelength dipole. The physical antenna length is a quarter-wavelength, but when operating over the ground plane the antenna performance resembles that of a half-wavelength dipole. Thus, the radiation pattern for a monopole antenna above a ground plane is similar to the half-wavelength dipole pattern, with a typical gain of approximately 2 dBi.

The common free space (i.e., not above ground plane) loop antenna (with a diameter of approximately one-third the wavelength) also displays the familiar donut radiation pattern along the radial axis, with a gain of approximately 3.1 dBi. At 1900 MHz, this antenna has a diameter of about 2 inches. The typical loop antenna input impedance is 50 ohms, providing good matching characteristics. However, conventional loop antennas are too large for handset applications and do not provide multi-band operation. As the loop length increases (i.e., approaching one free-space wavelength), the maximum of the field pattern shifts from the plane of the loop to the axis of the loop. Placing the loop antenna above a ground plane generally increases its directivity.

Printed or nucrostrip antennas are constructed using the patterning and etching techniques of printed circuit board processing, where the top metallization layer serves as the radiating element. These antennas are popular because of their low profile, the ease with which they can be fabricated and a relatively low fabrication cost. One such antenna is the patch antenna, comprising in stacked relation, a ground plane, a dielectric substrate and a radiating element. The patch antenna provides directional hemispherical coverage with a gain of approximately 3 dBi. Although small compared to a quarter or half wavelength antenna, the patch antenna has a relatively poor radiation efficiency, i.e., the resistive return losses are relatively high within its operational bandwidth. Disadvantageously, the patch antenna also exhibits a relatively narrow bandwidth. Multiple patch antennas can be stacked in parallel planes or spaced-apart in a single plane to synthesize a desired antenna radiation pattern that may not be achievable with a single patch antenna.

Given the advantageous performance of quarter and half-wavelength antennas, conventional antennas are typically constructed so that the antenna length is on the order of a half wavelength of the radiating frequency or a quarter wavelength with the antenna operated above a ground plane. These dimensions allow the antenna to be easily excited and operated at or near a resonant frequency, limiting the energy dissipated in resistive losses and maximizing the transmitted energy. But, as the operational frequency increases/decreases, the operational wavelength correspondingly decreases/increases. Since the antenna is designed to present a dimension that is a quarter or half wavelength at the operational frequency, when the operational frequency changes, the antenna is no longer operating at a resonant condition and antenna performance deteriorates.

As can be inferred from the above discussion of various antenna designs, each exhibits known advantages and disadvantages. The dipole antenna has a reasonably wide bandwidth and a relatively high antenna efficiency (or gain). The major drawback of the dipole, when considered for use in personal wireless communications devices, is its size. At an operational frequency of 900 MHz, the half-wave dipole comprises a linear radiator of about six inches in length. Clearly it is difficult to locate such an antenna in the small space envelope of today's handheld communications devices. By comparison, the patch antenna or the loop antenna over a ground plane present a lower profile resonant device than the dipole, but operate over a narrower bandwidth with a highly directional radiation pattern.

As discussed above, multi-band or wide bandwidth antenna operation is especially desirable for use with various personal or handheld communications devices. One approach to producing an antenna having multi-band capability is to design a single structure (such as a loop antenna) and rely upon the higher-order resonant frequencies of the loop structure to obtain a radiation capability in a higher frequency band. Another method employed to obtain multi-band performance uses two separate antennas, placed in proximity, with coupled inputs or feeds according to methods well known in the art. Each of the two separate antennas resonates at a predictable frequency to provide operation in at least two frequency bands. Notwithstanding these techniques, it remains difficult to realize an efficient antenna or antenna system that satisfies the multi-band/wide bandwidth operational features in a relatively small physical volume.

The “hand” or “body” effect must also be considered during the design of antennas for handheld communications devices. Although an antenna incorporated into such devices is designed and constructed to provide certain ideal performance characteristics, in fact all of the performance characteristics are influenced, some significantly, by the proximity of the user's hand or body to the antenna when the communications device is in use. When the hand of a person or other grounded object is placed close to the antenna, stray capacitances are formed between the effectively grounded object and the antenna. This capacitance can significantly detune the antenna, shifting the antenna resonant frequency (typically to a lower frequency), thereby reducing the received or transmitted signal strength. It is impossible to accurately predict and design the antenna to ameliorate these effects, as each user handles and grasps the personal communications device differently.

Each of the many antenna configurations discussed above have certain advantageous features, but none offer all the performance requirements desired for handset and other wireless communications applications, including dual or multi-band operation, high radiation efficiency, wide bandwidth, high gain, low profile and low fabrication cost.

### BRIEF SUMMARY OF THE INVENTION

According to one embodiment of the invention, an antenna comprises a ground plane, a radiating element overlying the ground plane, an arm extending from the radiating element, a shorting element connecting the ground plane and the radiating element, a feed terminal connected to the radiating element and wherein the antenna operates in at least two modes, each mode having a different resonant frequency.

### BRIEF DESCRIPTION OF THE DRAWINGS

The present invention can be more easily understood and the advantages and uses thereof more readily apparent when the following detailed description of the present invention is read in conjunction with the figures wherein:

FIG. 1 illustrates an antenna constructed according to the teachings of the present invention.

FIGS. 2A-2E illustrate various embodiments for the arm element of the antenna of FIG. 1.

FIG. 3 illustrates an equivalent circuit of the antenna of FIG. 1.

FIGS. 4 and 5 illustrate the current distribution of the antenna of FIG. 1 when operating in the dipole mode

FIG. 6 illustrates the radiation pattern of the antenna of FIG. 1 when operating in the dipole mode.

FIGS. 7 and 8 illustrate the current distribution of the antenna of FIG. 1 when operating in the patch mode

FIG. 9 illustrates the radiation pattern of the antenna of FIG. 1 when operating in the patch mode.

FIG. 10 illustrates an antenna constructed according to the teachings of the present invention installed in a communications handset device.

FIGS. 11A-11C and 12 illustrate various views of another embodiment of an antenna constructed according to the teachings of the present invention

FIG. 13 illustrates a return loss for the antenna embodiment of FIGS. 11A-11C, 12 and 13.

FIG. 14 illustrates yet another embodiment of an antenna constructed according to the teachings of the present invention.

FIG. 15 illustrates a return loss for the antenna embodiment of FIGS. 14.

FIG. 16 illustrates an antenna constructed according to the teachings of the present invention operating in conjunction with illustrated electronics components.

FIG. 17 illustrates a communications handset device for operating in conjunction with the various antennas of the present invention.

FIGS. 18-20 illustrate elements of another embodiment of an antenna according to the present invention.

FIG. 21 illustrates the current distribution for the antenna illustrated in FIGS. 18-20 when operating in the monopole mode.

FIG. 22 and 23 illustrate alternative elements for the antenna illustrated in FIGS. 18-20.

FIG. 24 illustrates the current distribution for the antenna illustrated in FIGS. 18-20 when operating in the patch mode.

In accordance with common practice, the various described features are not drawn to scale, but are drawn to emphasize specific features relevant to the invention. Reference characters denote like elements throughout the figures and text.

### DETAILED DESCRIPTION OF THE INVENTION

Before describing in detail the particular antenna apparatus according to the present invention, it should be observed that the present invention resides primarily in a novel and non-obvious combination of elements. So as not to obscure the disclosure with details that will be readily apparent to those skilled in the art, certain conventional elements and steps have been presented with lesser detail, while the drawings and the specification describe in greater detail other elements and steps pertinent to understanding the invention.

One antenna of the present invention comprises a physical structure that combines or integrates two different antenna types to achieve desired operating properties while limiting the antenna to a relatively small volume suitable for inclusion in a communications device, such as a handset. In one embodiment these two antenna types comprise a dipole antenna and a patch antenna. Combining these two antennas according to the teachings of the present invention allows the resulting antenna to achieve advantages derived from each individual antenna. That is, the single antenna of the present invention is capable of operating as two separate and distinct antennas, with different resonant frequencies, radiation pattern and bandwidths. Thus the present invention presents a compact antenna comprising a combination of different antenna element types with a common feed, for use especially in wireless handset communications devices.

In one embodiment, the antenna of the present invention operates in two modes, known as a dipole mode and a patch mode. Each operational mode corresponds to the excitation of a specific physical region of the antenna structure, i.e., a dipole region and a patch region. Thus the antenna exhibits multiple frequency resonances, with each resonant frequency associated with an operational mode. Advantageously, each resonant frequency can be independently established or adjusted by altering one or more physical parameters of the antenna structure. Generally, the patch mode resonant frequency is higher than the dipole mode resonant frequency.

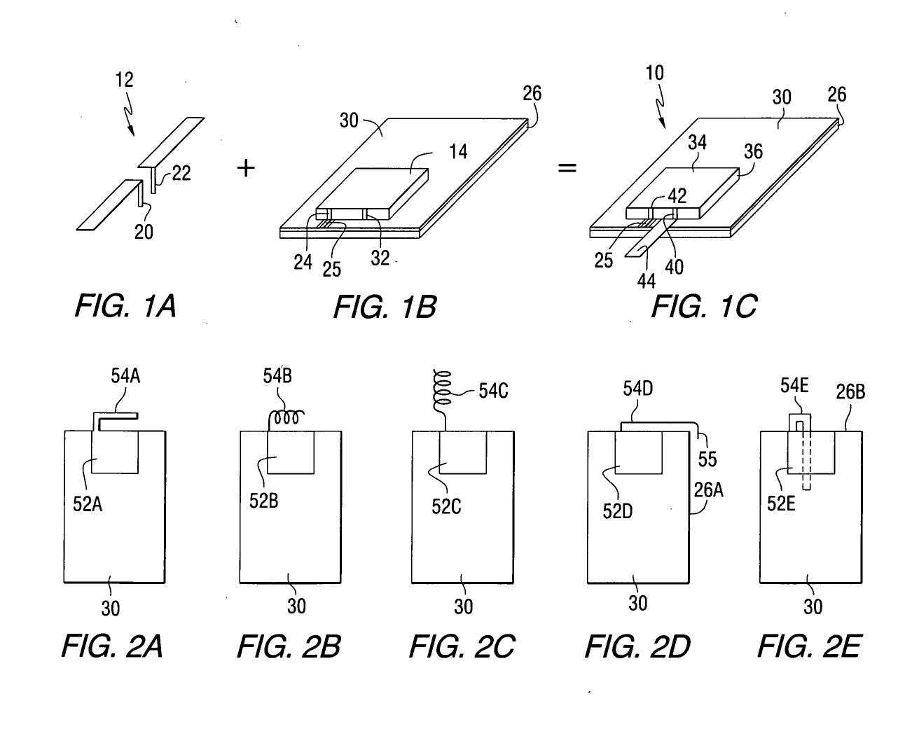

FIG. 1C illustrates an antenna 10 constructed according to one embodiment of the present invention, wherein the antenna 10 comprises a combination of a dipole antenna 12 of FIG. 1A and a shorted patch antenna 14 of FIG. 1B. The dipole antenna 12 comprises a ground terminal 20 and a feed terminal 22. The shorted patch antenna 14 is fed through a feed terminal 24 connected to a feed trace 25 extending to an edge of a printed circuit board (PCB) 26 on which is disposed a ground plane 30. Typically, a connector is physically attached to the edge of the PCB 16 and electrically connected to the feed trace 25 and the ground plane 30. The patch antenna 14 is shorted to the ground plane 30 through a ground terminal 32.

As further illustrated in FIG. 1C, the combined antenna 10 according to the present invention comprises a radiating element 34 spaced apart from the ground plane 30 with a dielectric material layer 36 disposed therebetween. The radiating element 34 is connected to the ground plane 30 via a shorting pin 40. Through the feed trace 25, a feed pin 42 is connected to a feed point of a communications device operable with the antenna 10 and the radiating element 34. An arm 44 extends from the radiating element 34.

FIGS. 2A-2E each depict a top view of several additional antennas 50A-50E constructed according to the teachings of the present invention. Each antenna 50A-50E includes a radiating element 52A-52E shorted to the ground plane 30 and electrically connected to an arm 54A-54E. As illustrated, the arms 54A-54E comprise different shapes and different orientations relative to the radiating elements 52A-52E, including, but not limited to, variously shaped conductive strips and variously configured conductive coils. The arm 54A comprises an inverted-L; the arm 54B comprises a loaded inverted-L; the arm 54C comprises a normal mode helix and the arm 54D comprises an inverted-L including an extension member 55, with a region of the arm 54D and the extension member 55 extending beyond a perimeter 26A of the printed circuit board 26. An arm 54E extends away from an edge 26B of the PCB 26, then downwardly below a plane of the PCB 26 and under the plane in a spaced apart relation thereto. Thus as can be seen, in certain embodiments a plane of the arm is parallel to a plane of the radiating element, and in other embodiments (e.g., the FIG. 2E) at least one region of the arms forms an acute angle with the radiating element plane. Generally, the arms 44/54A-54E comprise any shape suitable for use as an antenna element.

In an embodiment where the arms 44/54A-54E form an element of a half-wavelength dipole radiator, the arm may exhibit an effective electrical length of about a quarter wavelength. A region of the radiating element (generally the region proximate the connection between the arm and the radiating element) operates cooperatively with the arm, i.e., supplies current to the arm 44/54A-54E, to form the half-wavelength dipole antenna. Thus the effective electrical length of the overall dipole radiator is about one-half wavelength. In other embodiments, the arm has a length of less than a quarter-wavelength with the radiating element forming the remainder of the dipole radiator such that the total radiating wavelength is on the order of a half wavelength.

As shown in FIGS. 1C and 2A-2E in certain embodiments, at least a region of the arm 44/54A-54E extends beyond a perimeter of the ground plane 30. It is generally known that an antenna comprising a radiator operative over a ground plane exhibits relatively low radiation efficiency. According to the teachings of the present invention, it has been determined that locating at least a portion of the radiating element (e.g., the arm 44/54A-54E) beyond the ground plane perimeter increases both the radiating efficiency and the bandwidth of the antenna, when compared to a conventional dipole or patch antenna.

In the dipole mode, current flow through the arm 44 and a corresponding region of the radiating element 34, causes the antenna to operate as a dipole radiator, with the radiation pattern resembling the known dipole omnidirectional pattern. When operative in the patch mode, current flow through the patch causes the antenna structure to exhibit patch properties with the radiation directed primarily perpendicular to the plane of the patch. In both cases, the antenna bandwidth is wider than provided by a conventional dipole or patch antenna.

Thus the antenna of the present invention operates as one of two different antenna types, from a single feed, avoiding the complex feed and branch networks and separate antenna structures of the prior art. Further since the two antennas share radiating structures they provide a compact antenna arrangement especially suitable for use in a wireless communications handset.

Returning to FIG. 1C, the shorting pin 40 connects the radiating element 34 to the ground plane 30. A signal is supplied to the antenna 10 via the feed trace 25 and the feed pin 42 when operative in the transmitting mode. In the receiving mode, the received signal is present at the conductive trace and input to receiving and processing elements of the communications device with which the antenna 10 operates. According to one embodiment, the ground plane 30 comprises a ground plane of a printed circuit board or ceramic board on which electronic components are mounted, wherein the electronic components form operative circuits for the communications device.

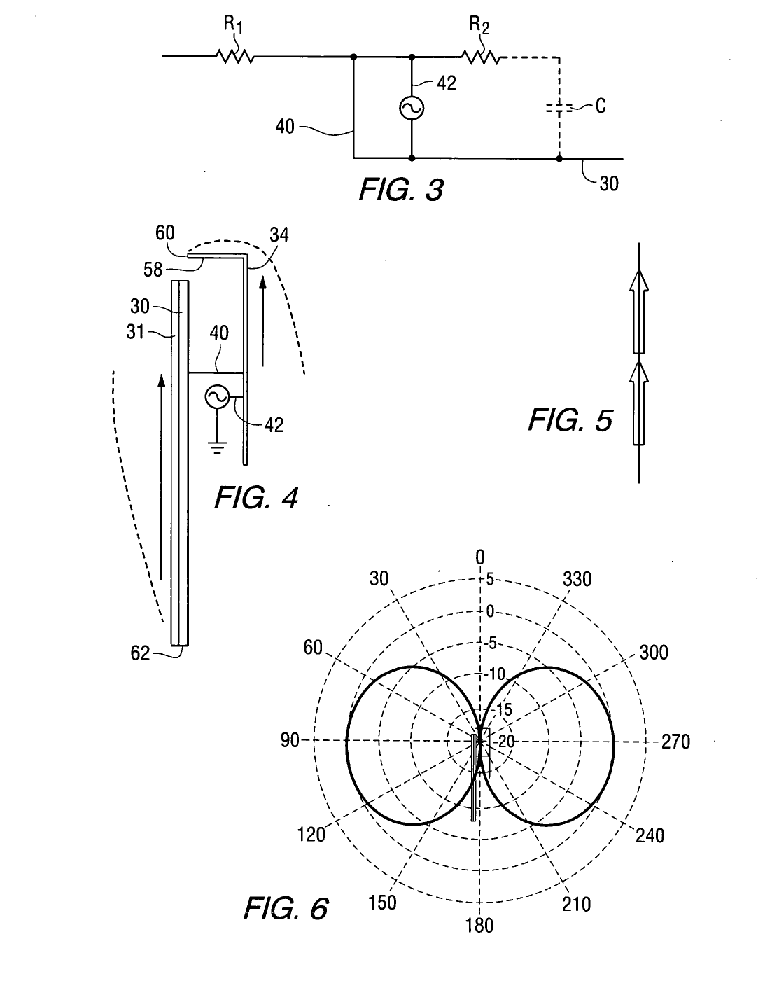

One embodiment of an antenna according to the present invention is shown schematically in FIG. 3. Resistances R₁ and R₂ each represent a distributed resistance associated with the arm 44 and the radiating element 34, respectively. A capacitor C represents the parasitic capacitance between the ground plane 30 and the radiating element 34.

FIG. 4 illustrates the current distribution (direction and magnitude) for an antenna constructed according to the teachings of the present invention operating in the dipole mode. As can be seen, in the dipole mode a region of the ground plane 30 carries current and thus acts as a functional element of the dipole antenna. The radiating element 34 feeds current to an arm 58 to provide dipole mode operation. Note the arm 58 is shaped differently than the arms 44 and 54A-54E, but provides the same functionality as described herein.

From FIG. 4 it can be seen that the current maxima occur in a region of the feed pin 42 and the shorting pin 40, while the minima occur at ends 60 and 62 of current-carrying regions in the dipole mode. The antenna drives current on the ground plane 30 so that the entire structure, including the ground plane 30 and the arm 58 radiate electromagnetic energy. Since the current direction is the same on the ground plane 30 and the arm 58, the entire structure can be analyzed as a linear current source.

FIG. 5 illustrates the equivalent current source model for the antenna of FIG. 4 operating in the dipole mode. This is the antenna current distribution for a typical dipole antenna that creates the omnidirectional pattern (see FIG. 6) at a frequency where the effective electrical length of each dipole element is about one-quarter of a wavelength, for a total effective electrical length of about one-half of a wavelength. Therefore, the antenna size can be extremely small while providing the wide bandwidth and high antenna radiation efficiency of a dipole antenna.

The current density in a prior art patch antenna is highest along the patch edges to the ground plane and decreases in a direction toward the ground plane edges. When the antenna of the present invention operates in the dipole mode, regions of the radiating element 34, the ground plane 30 and the arm 58 radiate, although the current density in the ground plane is lower than the current density in the other elements as the ground plane current tends to spread throughout the ground plane.

When the antenna of the present invention is operative with a communications handset, the ground plane 30 is typically connected to various other grounded elements in the handset. Thus these handset components may also radiate energy. This feature increases the antenna efficiency, without increasing the antenna volume, i.e., the volume of the handset that is dedicated to the antenna. As is known, the handset antenna is relatively small and not likely to increase as users continue to demand smaller, lighter and feature-rich handset communications devices. The inventors have discovered that by driving current without field cancellation (i.e., the current induced fields do not destructively interfere in the radiation field) in both the antenna elements and the ground plane, the resulting antenna provides high gain, wide bandwidth and high antenna efficiency.

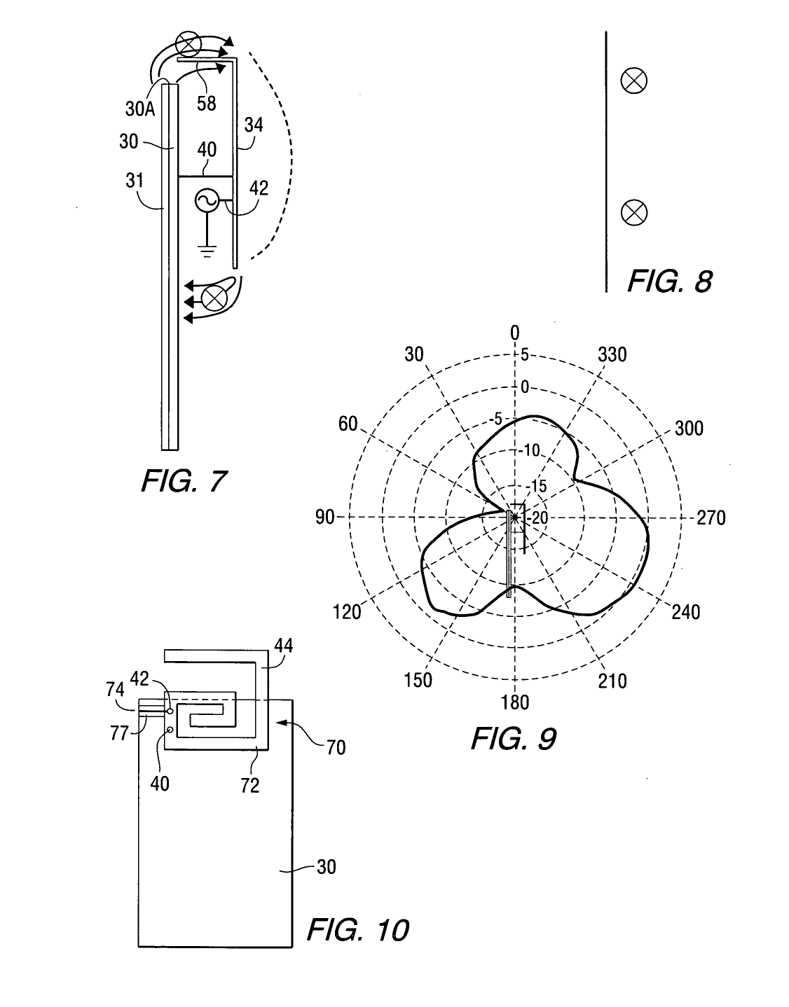

FIG. 7 illustrates the current distribution (magnitude and direction as represented by the arrowheads) and induced magnetic field (as represented by the encircled crosses, representing a magnetic field in a direction into a plane of the paper) for the patch operational mode of the antenna of the present invention. In this mode, the arm 58 presents a relatively high impedance at the patch frequency and thus a relatively small current flows within the arm 58, compared with the current flow in the radiating element 34.

With the current distribution as shown in FIG. 7, most of the energy is radiated perpendicular to a plane comprising the patch, i.e., comprising the radiating element 34. The antenna operates as a patch antenna and can thus be analyzed as two parallel magnetic current sources over a ground plane. The equivalent magnetic current source model is illustrated in FIG. 8 and the measured radiation pattern in FIG. 9.

As is known, the bandwidth of a conventional patch antenna is principally controlled by an electrical field path length between an edge of the radiating element 34 and the ground plane 30. This path length is in turn related to a distance between the radiating element 34 and the ground plane 30. As illustrated in FIG. 7, the antenna of the present invention provides a longer field path length than the prior art patch antenna due to a region of the radiating element 34 extending beyond an edge 30A of the ground plane. In the patch mode little current flows in the arm 58.

According to one embodiment of the present invention, the antenna operates in the dipole mode at a lower frequency than the patch mode. Thus the antenna operates in the dipole mode within a predetermined frequency band and in the patch mode in a higher frequency band. Changes to the size of the ground plane 30 and its physical relation to the radiating element 34 primarily affect dipole mode operation, e.g., increasing the bandwidth with increasing ground plane size.

In one embodiment, the presented antenna has the dimensions and operational parameters set forth below. Both modes (i.e., the dipole mode at a resonant frequency of about 850 MHz and the patch mode at a resonant frequency of about 1900 MHz) exhibit a relatively wide bandwidth and a relatively high radiation efficiency.
Size of radiating element: 1″×0.5″×0.18″ (height, including the arm)
Bandwidth: 70 MHz at cellular frequency of 850 MHz (VSWR<3:1)
   140 MHz at PCS frequency of 1900 MHz (VSWR<2:1)
Antenna efficiency: 70% at GSM frequency (900 MHz)
   78% at PCS frequency (1900 MHz)
Antenna Gain: 0.5 dBi at cellular frequency (850 MHz)
   3.0 dBi at PCS frequency (1900 MHz)

In another embodiment of the present invention, the antenna operates at 800 MHz (low band resonant frequency or dipole mode) and 1900 MHz (high band resonant frequency or patch mode). A handset communications device employing such an antenna is therefore operable in the cellular telephone band, the GSM band and the personal communication system (PCS) frequency bands. In another embodiment, the antenna is resonant at about 1500 MHz (low band or dipole mode) and about 1900 MHz (high band or patch mode). To effect these resonant frequency changes, the spacing between the shorting pin 40 and the feed pin 42 is modified, e.g., the resonant frequency declines in response to decreasing the spacing and vice versa. At certain spacings the VSWR, and thus the antenna bandwidth, is optimized.

Changing the ground terminal/feed terminal spacing permits independent tuning of the resonant frequencies in the dipole and the patch modes, i.e., the two resonant frequencies are not harmonically related and one can be modified while the other remains substantially constant. Thus an antenna resonant at any two operating frequencies can be designed.

Note that in the additional embodiments set forth above, in response to changing the ground terminal/feed terminal spacing the upper resonant frequency remains unchanged (at about 1900 MHz), while the lower resonant frequency is nearly doubled (800 MHz to 1.5 MHz). In yet another embodiment, a selected ground terminal/feed terminal spacing creates a dipole resonant condition at about 800 MHz and a patch resonant condition at about 2600 MHz.

The resonant frequencies set forth above are merely exemplary and can be changed by altering the ground terminal/feed terminal spacing, changing a length of the arm 44/54A-54E/58 and changing an area of the radiating element 34. It should also be noted that changing a length of the arm 44/54A-54E/58 changes the capacitance between the arm and the ground plane, which in turn changes the antenna operating characteristics.

In all embodiments and at all resonant frequencies the antenna exhibits relatively wide bandwidth and a relatively high radiation efficiency.

FIG. 10 illustrates another embodiment according to the present invention wherein an antenna 70 comprises a spiral-shaped radiating element 72 comprising multiple turns or loops; the arm 44 comprises a region of an outer turn of the multiple turns. The shorting pin 40 and the feed pin 42 are also illustrated. A conductive trace 74 extends from the feed pin 42 through a region 77 devoid of conductive material forming the ground plane 30. The conductive trace 74 is further connected to a signal feed of the communications device with which the antenna is operative. In one application, the printed circuit board 26 (see FIG. 7 for example) comprises a plurality of components operative with the antenna for transmitting and receiving a signal. In such an application, the conductive trace 74 is routed to appropriate components that provide the signal to be transmitted when the communications device is operative in the transmit mode. In the receive mode, the conductive trace 74 supplies the received signal to the appropriate components.

The antenna 70 exhibits both patch and dipole operational modes at different resonant frequencies as discussed above. The bandwidth and resonant frequency in one or both of the operational modes can be increased or decreased by modifying various physical features of the antenna 70, including changing a shape of the spiral, adding or deleting spiral arms to increase or decrease a spiral length and increasing or decreasing an area of the spiral openings to effect the extent to which the spiral approaches a solid surface. Adding spiral arms (i.e., increasing the spiral length) lowers the patch mode resonant frequency. Increasing a distance between the ground plane 30 and the radiating element 72 increases the bandwidth in both operating modes, especially the bandwidth at the high resonant frequency.

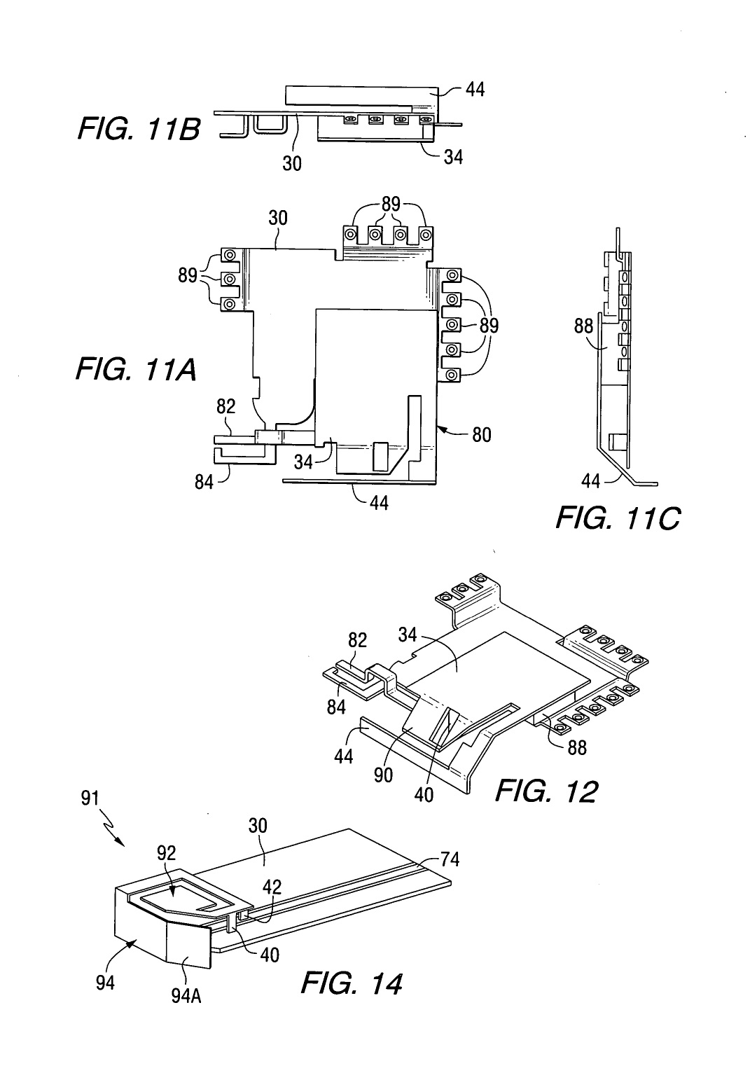

FIGS. 11A, 11B and 11C illustrate three orthogonal views of an antenna 80 constructed according to another embodiment of the present invention. The top view of FIG. 11A illustrates a feed terminal 82 and a ground terminal 84 for electrically connecting the antenna 80 to a handset communications device. The feed terminal 82 is further connected to the antenna feed pin 42 and the ground terminal 84 is further connected to the antenna shorting pin 40. The side view of FIG. 11C illustrates a spacer or standoff 88 disposed between the radiating element 34 and the ground plane 30. The resonant frequency of the antenna 80 is responsive to the dielectric constant of the spacer 88. Increasing the dielectric constant decreases the resonant frequency.

Ground fingers 89 disposed about the periphery of the ground plane 30 provide ground plane connections to ground surfaces within the communications handset device.

FIG. 12 shows the antenna 80 in a perspective view. Although the spacer 88 is not required, its use provides a higher dielectric constant than air in a region between the radiating element 34 and the ground plane 30 and thus presents a structurally smaller antenna than one having an air dielectric, without modifying the antenna's performance characteristics. In this embodiment, the antenna is approximately 1.2 inches long (excluding the ground plane 30), 0.8 inches wide, and the radiating element 34 is about 4-9 mm above the ground plane 30. Generally, reducing the height of the radiating element 34 reduces the antenna bandwidth.

To increase an area of the radiating element 34, a region 90 extends downwardly away from the radiating element 34. The region 90 or other similar conductive regions extending from the radiating element 90 may be useful for tuning the high band performance.

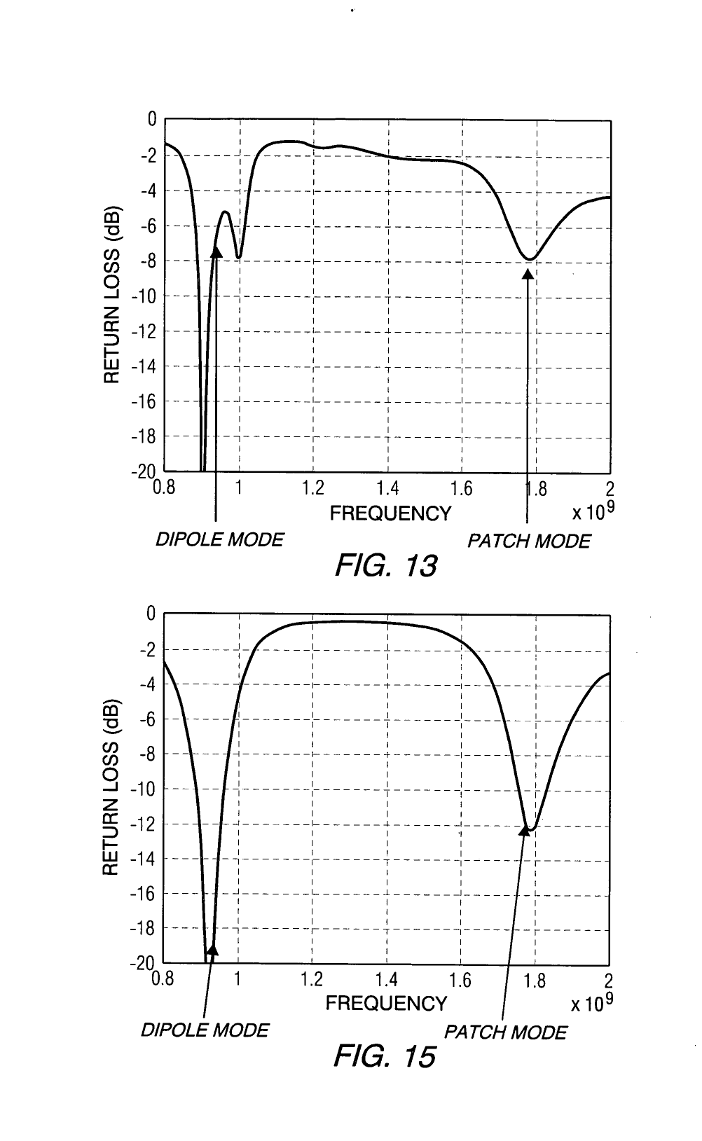

Antenna return loss is plotted in FIG. 13, indicating the operational bands for the dipole and the patch modes.

FIG. 14 illustrates an embodiment of an antenna 91 constructed according to the teachings of the present invention wherein a radiating element 92 comprises a spiral conductor and an arm 94 disposed perpendicular to a plane of the radiating element 92. A free arm end 94A is directed inwardly (i.e., in a direction toward the ground plane 30) from a length axis of the arm 94. In this embodiment the antenna 91 (excluding the ground plane 30) is approximately 1.0 inches long, 0.5 inches wide. The radiating element 92 is about 0.2 inches above the ground plane 30. The return loss is plotted in FIG. 15, which identifies the operational bands for the dipole mode and the patch mode.

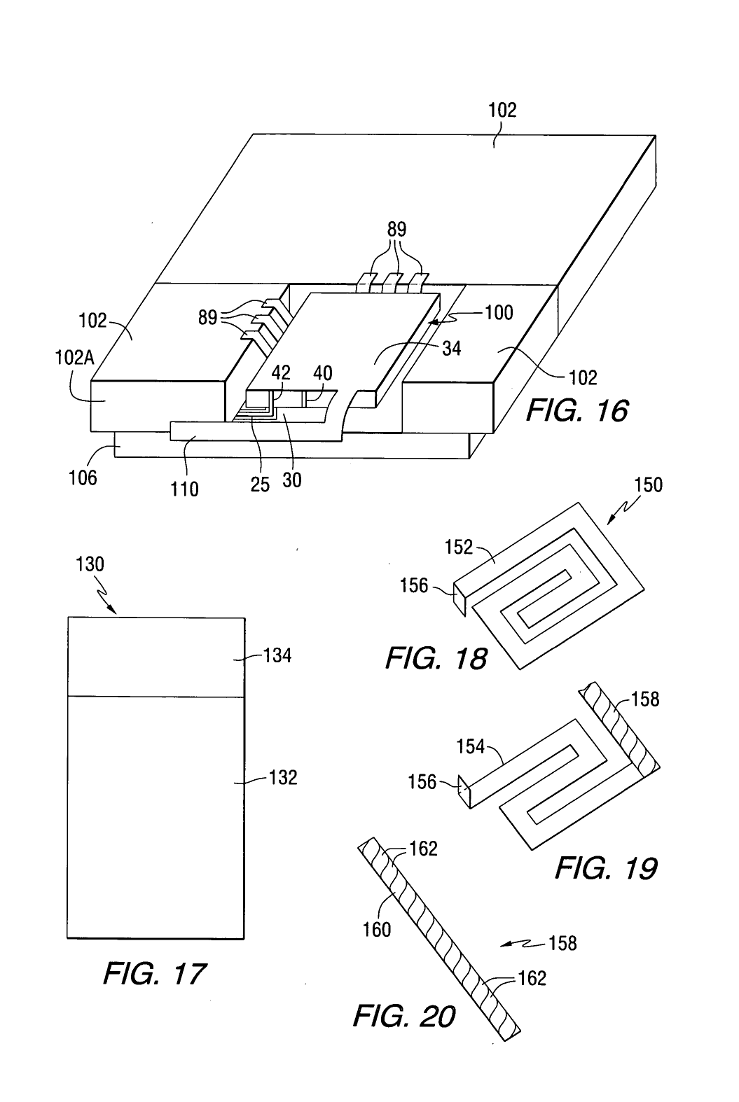

FIG. 16 illustrates generally one application for an antenna 100 of the present invention, wherein the antenna 100 is disposed within a cavity formed by a plurality of electronics modules 102 (e.g., radio frequency and intermediate frequency amplifiers, filters, demodulators, modulators) and a battery 106 of a wireless communications device.

The ground fingers 89 are connected to ground elements (not visible in FIG. 16) associated with the electronics modules 102 to reduce ground loop currents that can propagate from the modules 102 into the antenna 100 and also to shield the antenna 100.

An arm 110 extends from the radiating element 34. Locating the arm 110 at a distance from the modules 102 advantageously reduces the radio frequency interference to which the arm 110 is subjected. Typically, the element of FIG. 16 are enclosed in a housing or cover (not shown) of the wireless communications device such that the arm 110 is disposed between an inner surface of the housing and the electronics modules 102. The antenna 100 is fed through the feed pin 42 and the feed trace 25. Lengthening the arm 110 generally lowers the resonant frequency in an operational mode where the arm 110 carries significant current. The resonant frequency can also be lowered by decreasing the distance between the arm 110 and the ground plane 30, increasing the capacitive reactance of the arm and thereby lowering the resonant frequency.

In another embodiment, a feed terminal finger, similar to one of the ground fingers 89, replaces the feed pin 42 and the feed trace 25.

In yet another embodiment, the electronics modules 102 are replaced by planar printed circuit boards having components mounted thereon and ground and signal traces for connecting the components.

In one embodiment, the distance between the radiating element 34 and the underlying ground plane is about 0.2 inches. The antenna 100 operates in three service bands, with one antenna resonant band including a band around about 900 MHz (e.g., the GSM band) and a second antenna resonant band including frequencies around about 1800 and 1900 MHz (e.g., the PCS and DCS bands).

Certain other embodiments of antennas of the present invention, as described below, are useful for receiving video signals (including broadcast digital television signals and digital data streaming signals) from terrestrial-based transmitting sites, such as cellular telephone transmitters. Certain of these video signals are transmitted in the frequency range of about 118 MHz to 210 MHz. At these frequencies, a half-wavelength dipole antenna is about 1.25 m long, clearly impractical for use with a handset communications device. Use of a monopole antenna (a quarter wavelength long and disposed over a ground plane) for such a handset would not be expected to provide acceptable performance, as a size of the printed circuit ground plane is limited by the size of the handset and is therefore smaller than required for good antenna performance.

FIG. 17 illustrates a conventional communications device handset 130 comprising a printed circuit board region 132 further comprising a printed circuit board, including a ground plane and various electronic components associated with operation of the handset. An antenna is disposed generally within an antenna region 134. These regions designations are intended to generally indicate the location of the printed circuit board and the antenna, as those skilled in the art recognize that other locations for the printed circuit board and the antenna are possible and may be desirable in certain handset communications devices.

FIGS. 18 and 19 illustrate an antenna 150 exhibiting a monopole operating mode and a patch operating mode for use with the handset device of FIG. 17. The monopole mode is useful for receiving the video signals in the frequency range of about 180-200 MHz and the patch mode for providing cellular telephone communications at a resonant frequency of about 800 MHz (for CDMA operation).

The antenna 150 comprises a top element 152 (FIG. 18), a bottom element 154 (FIG. 19) and a shorting element 156 connected therebetween. As can be surmised, the top and the bottom elements 152 and 154 are disposed in parallel planes, with the top element 152 overlying the bottom element 154 and the shorting element 156 extending between the top element 152 to the bottom element 154. A helical antenna 158 comprising in one embodiment a substrate 160 having helical windings 162 thereabout, is connected to a terminal end of the bottom element 154 as shown in FIG. 19. The helical antenna 158 is further illustrated in FIG. 20. In one embodiment, the helical antenna 158 comprises a telescoping feature to adjust a length during monopole mode operation. The electrical length of the helical antenna 158 does not substantially affect the patch mode resonant frequency or bandwidth.

According to the embodiment of FIGS. 18 and 19, the top and the bottom elements 152 and 154 each comprise electrical meanderlines that contribute an electrical length to the antenna 150, where the electrical length is greater than the actual physical length. This feature permits use of a physically shorter helical antenna 158 to achieve a desired resonant condition. In one embodiment, a length of the helical antenna 158 is about 6 cm and a diameter is about 4 mm. These dimensions are merely exemplary as other antenna sizes can be used according to the present invention.

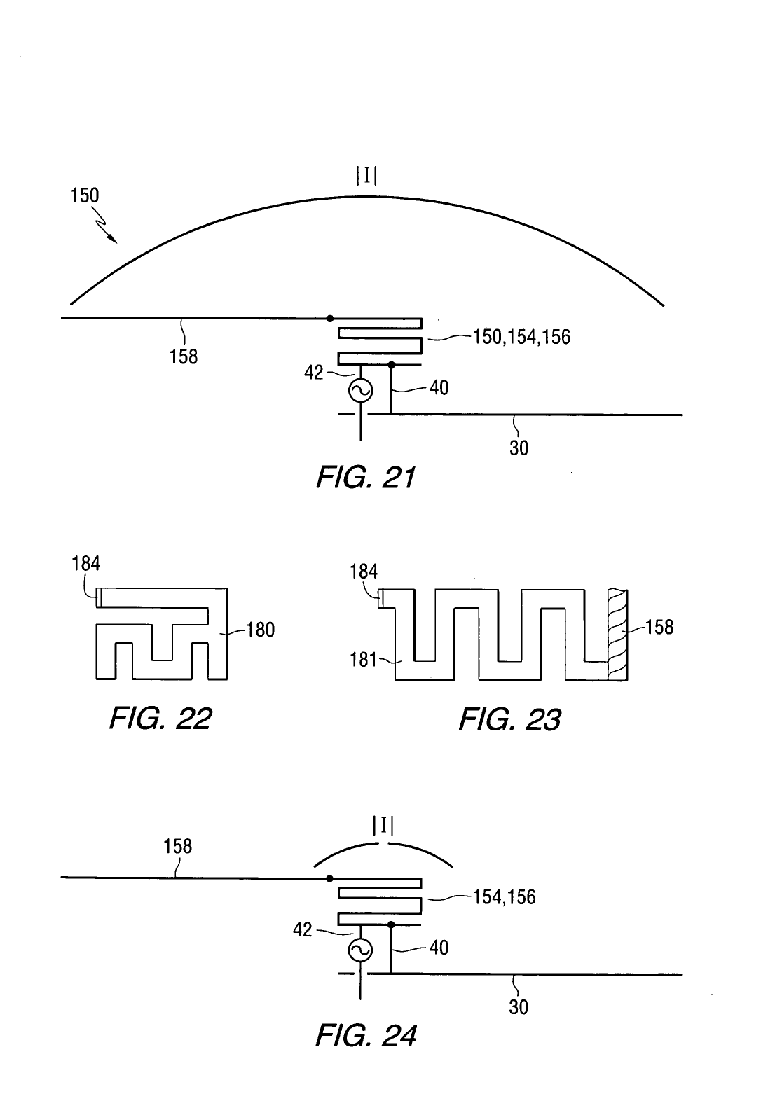

FIG. 21 illustrates the antenna 150 in schematic form when operating in the monopole mode, including the shorting pin 40 and the feed pin 42. Note that the ground plane 30 forms a portion of the monopole antenna due to a current in the ground plane. However, a ground plane is not disposed under the helical antenna 158. A current magnitude |I| is also illustrated in FIG. 21. The antenna 150 exhibits a radiation pattern of a conventional monopole antenna over a ground plane.

Although the top and bottom elements 152 and 154 are illustrated as spiral meanderlines in FIGS. 19, 20 and 22, this is not necessarily required. FIGS. 22 and 23 illustrate zigzag meanderline conductors 180 and 181 that can be employed as the top and/or the bottom elements 152 and 154. A region 184 of each zigzag meanderline element 180 and 181 to which the shorting element 156 is connected is also illustrated. Other electrical length-compensating shapes can also be employed, as known by those skilled in the art.

FIG. 24 illustrates the current distribution of the antenna 150 when operating in the patch mode with a resonant frequency of about 800 MHz. Note that little current flows in the helical antenna 158 during patch mode operation.

An antenna architecture has been described as useful for a communications device. While specific applications and examples of the invention have been illustrated and discussed, the principals disclosed herein provide a basis for practicing the invention in a variety of ways and in a variety of antenna configurations. Numerous variations are possible within the scope of the invention. The invention is limited only by the claims that follow.

What is claimed is:

1. An antenna comprising:
a ground plane;
a radiating element overlying the ground plane;
an arm extending from the radiating element;
a shorting element connecting the ground plane and the radiating element;
a feed terminal connected to the radiating element; and
wherein the antenna operates in at least two modes, each mode having a different resonant frequency.

2. The antenna of claim 1 having a first current distribution when operating in a first mode different from a second current distribution when operating in a second mode.

3. The antenna of claim 2 wherein the first current distribution comprises current in a region of the radiating element, in a region of the ground plane and in the arm.

4. The antenna of claim 2 wherein the second current distribution comprises current principally in the radiating element.

5. The antenna of claim 2 having a first bandwidth when operating in the first mode different from a second bandwidth when operating in the second mode.

6. The antenna of claim 2 operative in a dipole mode according to the first current distribution and operative in a patch mode according to the second current distribution, wherein the resonant frequency of the first current distribution is lower than the resonant frequency of the second current distribution.

7. The antenna of claim 1 wherein the radiating element is substantially parallel to the ground plane.

8. The antenna of claim 1 wherein the arm comprises a planar structure.

9. The antenna of claim 1 wherein a region of the arm extends beyond a periphery of the ground plane.

10. The antenna of claim 1 wherein the arm comprises an L-shaped planar structure or a U-shaped planar structure.

11. The antenna of claim 1 wherein the arm comprises a helical coil.

12. The antenna of claim 1 wherein an electrical length of the arm is selected to form a dipole antenna in combination with a region of the radiating element and a region of the ground plane.

13. The antenna of claim 1 wherein the radiating element comprises a spiral-shaped radiating element or a substantially solid planar element.

14. The antenna of claim 1 further comprising a dielectric material disposed between the radiating element and the ground plane, wherein the dielectric material has a dielectric constant greater than a dielectric constant of air.

15. The antenna of claim 1 wherein a resonant frequency of a dipole mode is responsive to a ground plane size.

16. The antenna of claim 1 wherein a first operational mode comprises a resonant frequency of about 800 MHz and a second operational mode comprises a resonant frequency of about 1900 MHz.

17. The antenna of claim 1 having a resonant frequency responsive to a distance between the shorting element and the feed terminal.

18. The antenna of claim 1 wherein the radiating element comprises a multi-loop spiral element and the arm comprises a region of an outer loop thereof.

19. The antenna of claim 1 wherein the radiating element comprises a first region substantially parallel to the ground plane and a second region forming an acute angle with the first region and extending in a direction toward the ground plane.

20. The antenna of claim 1 wherein the arm comprises a first region extending from the radiating element and disposed in a first plane substantially perpendicular to a plane of the radiating element and a second region disposed in a second plane different from the first plane.

21. The antenna of claim 1 wherein the arm comprises a first region disposed in a first plane and extending in a direction away from the radiating element and beyond the periphery of the ground plane, and a second region extending from the first region, wherein the second region is disposed in a second plane different from the first plane.

22. The antenna of claim 20 wherein the first plane and the second plane are substantially perpendicular.

23. An antenna comprising:
a ground plane;
a meanderline radiating element overlying the ground plane;
an arm extending from the radiating element;
a shorting element connecting the ground plane and the radiating element;
a feed terminal connected to the radiating element; and
wherein the antenna operates in at least two modes, each mode having a different resonant frequency.

24. The antenna of claim 23 wherein a first mode comprises a monopole mode and a second mode comprises a patch mode.

25. The antenna of claim 23 wherein the meanderline radiating element comprises an upper meanderline element in substantially parallel orientation with and electrically connected to a lower meanderline element, and wherein a terminal end of the lower meanderline element receives the arm.

26. The antenna of claim 23 wherein the arm comprises a helical radiating element.

27. The antenna of claim 23 wherein the antenna operates in a first mode having a resonant frequency of about 180-200 MHz and operates in a second mode having a resonant frequency of about 800 MHz.

28. A communications handset comprising
a substrate having electronic components mounted thereon and further comprising a ground region;
an antenna operative with the electronic components, comprising:
a ground plane connected to the ground region;
a radiating element overlying the ground plane;
an arm extending from the radiating element;
a shorting element connecting the ground plane and the radiating element;
a feed terminal connected to the radiating element; and
wherein the antenna operates in at least two modes, each mode having a different resonant frequency to permit operation of the communications handset at two resonant frequencies.

29. The communications handset of claim 28 further comprising structural components including a handset case, wherein certain of the structural components are connected to the ground region

30. The communications handset of claim 29 wherein the antenna exhibits a first current distribution when operating in a dipole mode different from a second current distribution when operating in a patch mode, wherein certain of the structural components radiate energy when the antenna is operative in the dipole mode.

31. The communications handset of claim 29 wherein the arm comprises a helical element extending from the handset case, and wherein the antenna operates in a monopole mode in which substantial energy is radiated from the helical antenna or operates in a patch mode in which substantial energy is radiated from the radiating element.

32. A communications handset comprising
a substrate having electronic components mounted thereon and further comprising a ground region;
an antenna operative with the electronic components, comprising:
a ground plane connected to the ground region;
a lower meanderline element overlying the ground plane;
an upper meanderline element substantially parallel to and electrically connected to the lower meanderline element
an arm extending from the lower meanderline element;
a shorting element connecting the ground plane and the lower meanderline element;
a feed terminal connected to the lower meanderline element; and
wherein the antenna operates in at least two modes, each mode having a different resonant frequency.
